(19) United States
(12) Patent Application Publication
(10) Pub. No.: US 2014/0018047 A1
(43) Pub. Date: Jan. 16, 2014

(54) MOBILE APPLICATION FOR EXECUTING VOTING EVENTS USING IMAGES BETWEEN SMART PHONES, COMPUTERS, AND OTHER COMPUTING DEVICES

(71) Applicant: WILLIAM MATTHEW RADER, LOS ANGELES, CA (US)

(72) Inventor: WILLIAM MATTHEW RADER, LOS ANGELES, CA (US)

(21) Appl. No.: 13/545,009

(22) Filed: Jul. 10, 2012

(51) Int. Cl. H04W 4/00

(52) U.S. Cl. 455/414.1

(57) ABSTRACT

A Mobile Application for Executing Voting Events using images between smart phones includes Receiving a sequence of images, Re-sizing said sequence of images in order to display all images simultaneously onto the display interface of the mobile phone, Merging the sequence of images into one image and displaying the merged image onto the display interface of the smartphone, Displaying for the selection of the user at least one recipient to whom the message is intended to be sent, and Attaching a message to the merged image a prompt to vote. This Mobile Application for Executing Voting Events using images between smart phones is used for the purpose of requesting a plurality of users/voters to give their opinions on a plurality of images, or objects within those images.

### FIELD OF THE INVENTION

The present invention is in the area of smartphones, computers, and related products, and more particularly pertains to a Mobile Application for Executing Voting Events using images between smart phones, computers, and related products.

### BACKGROUND OF THE INVENTION

The proliferation of social media through various websites such as Facebook®, Twitter®, and Google®+has underscored the powerful demand amongst society for a platform through which they may be able to connect with their friends, family, co-workers, etc. in a panoply of ways which just years ago was unimaginable. Through these social media platforms, users can communicate through various multimedia such as video, images, etc. which are not possible or may be unwieldy through telephone communications alone.

One recent phenomenon which some people have noticed is a method through which a person, or a business may harness the massive power of connecting to large numbers of people quickly and prompting and receiving feedback. This trend is sometimes referred to as “crowd-sourcing”. Through crowd-sourcing, people or businesses can access powerful insights from customers, employees, or others to gain important information about their products or services.

Along similar lines, businesses have long since used an indispensable marketing tool to help them better create products and services tailored specifically to the needs of their target demographics. This process is sometimes referred to as “focus groups”. Through focus groups, a person or business can gain an accurate understanding about the strengths and weaknesses of their products, and what changes, if any, may best serve the research and development stages of their business by simply asking random people to honestly give their opinions on various products, services, movies, political candidates, advertising messages, etc.

Therefore, what is needed in the art is a method which enables a person or a business to disseminate a series of images which are juxtaposed onto their smartphones for the purpose of voting. Recipients of those images can then vote, or rate, those images, and relay those results back to the primary user or business.

### SUMMARY OF THE INVENTION

It is an object of the present invention to provide an apparatus for the purpose of enabling a user to take a series of pictures or images with their smartphone, merge those images onto one screen, and then enable the user to conduct a vote amongst his or her friends regarding those images. In a sense, through this technique, a user may be able to create their own “focus group” through which they can gain accurate insight about a particular product, service, movie, marketing message, political candidate, or the like. This process is novel in the sense that no longer will the power of focus groups, A/B testing, split-testing be completely within the province of large Fortune 500 companies. Instead, entrepreneurs with a smartphone can quickly do their own market research through the methods described herein provided they have access to a plurality of recipients to whom the messages will be sent for the purposes of conducting a vote.

In one embodiment the Mobile Application for Executing Voting Events using images between smart phones includes a.) Capturing and/or Receiving a sequence of images, b.) Re-sizing the sequence of images in order to display all images simultaneously onto the display interface of the mobile phone, c.) Merging the sequence of images into one image and d.) Displaying the merged image onto the display interface of the smartphone, e.) Displaying for the selection of the user at least one recipient to whom the message is intended to be sent, f.) Attaching a message to the merged image a prompt to vote, g.) Activating the plurality of zones by linking the zones to a voting event, h.) Receiving a signal response from a voter with respect to the results of the voting event, and i.) Prompting user to attach a return message.

### BRIEF DESCRIPTION OF THE DRAWING FIGURES

FIG. 1 is a block diagram of an embodiment of the present invention.

FIG. 2 is a plan view of an embodiment of the present invention.

FIG. 3 is a plan view of an embodiment of the present invention.

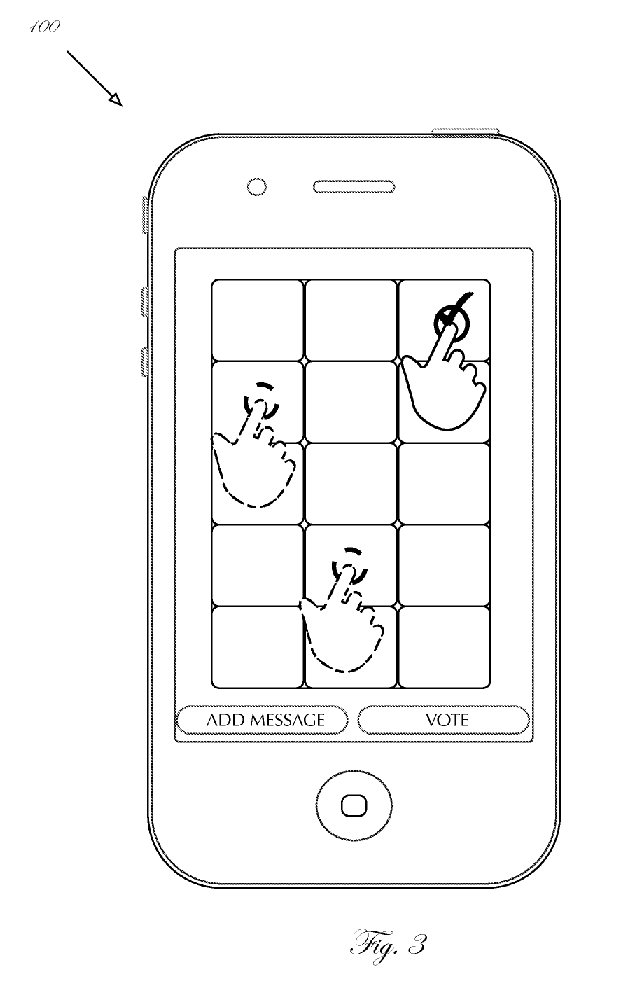

FIG. 4 is a plan view of an embodiment of the present invention.

FIG. 5 is a plan view of an embodiment of the present invention.

### DETAILED DESCRIPTION

According to an embodiment of the present invention, a unique Mobile Application for Executing Voting Events using images between smart phones 100 is provided for the purpose of enabling a user to create a voting event by taking and/or receiving a series of pictures or images from a smartphone, disseminating those images to other smartphone users, and receiving the votes from those users. The present invention is described in enabling detail below.

The following detailed description includes references to the accompanying figures, which form a part of the detailed description. The figures, which generally comprise screenshots of web pages or handheld devices, illustrate exemplary embodiments in which the subject matter may be practiced. These embodiments, which are also referred to herein as “examples”, are also referred to herein as “embodiments”, are described in enough detail to enable those skilled in the art to practice the subject matter. The embodiments may be combined, other embodiments may be used, or structural, logical, and electrical changes may be made without departing from the scope of the present subject matter. The following detailed description is, therefore, not to be taken in a limiting sense.

For the purposes of the present invention, the term “smartphone” or “mobile device” shall include, but not be limited to cellular phones with capabilities of sending and receiving text messages, taking and processing images with an integrated camera, accessibility to the internet, mobile telephony capabilities, the ability to run applications (ie “apps”), and other functions typically associated with smartphones. Although the most popular mobile operating systems are Apple's® iOS, and Google's® Android® operating systems, the embodiments described herein may conceivably be used on other similar operating systems in the future.

Moreover, the following embodiments are not necessarily restricted for use with just smart phones. Other embodiments may be executable on tablets such as Apple's® iPad®, iPod, and other related products. Moreover, in some cases, the recipients may respond and interact with various voting events, and other communications via a laptop computer, desktop computer, and the like. As such, the scope of the following embodiments is not meant to be restricted to smart phones, rather, the scope shall further include all devices capable of running or executing applications and which can respond and interact with the following embodiments.

For the purposes of the present invention, the term “voting event” shall refer to the process through which a user will have their recipients vote or rate the series of images which are merged together.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” and “achieve” to describe the disclosed methods. These terms are high-level abstractions of the actual operations that are performed. The actual operations that correspond to these terms may vary depending on the particular implementation and are readily discernible by one of ordinary skill in the art.

As used herein, the term “client” refers to a company, group, or individual that uses a system to facilitate a voting event in the manner described herein. As used herein, a “user” is any person that accesses the system to for the purpose of voting.

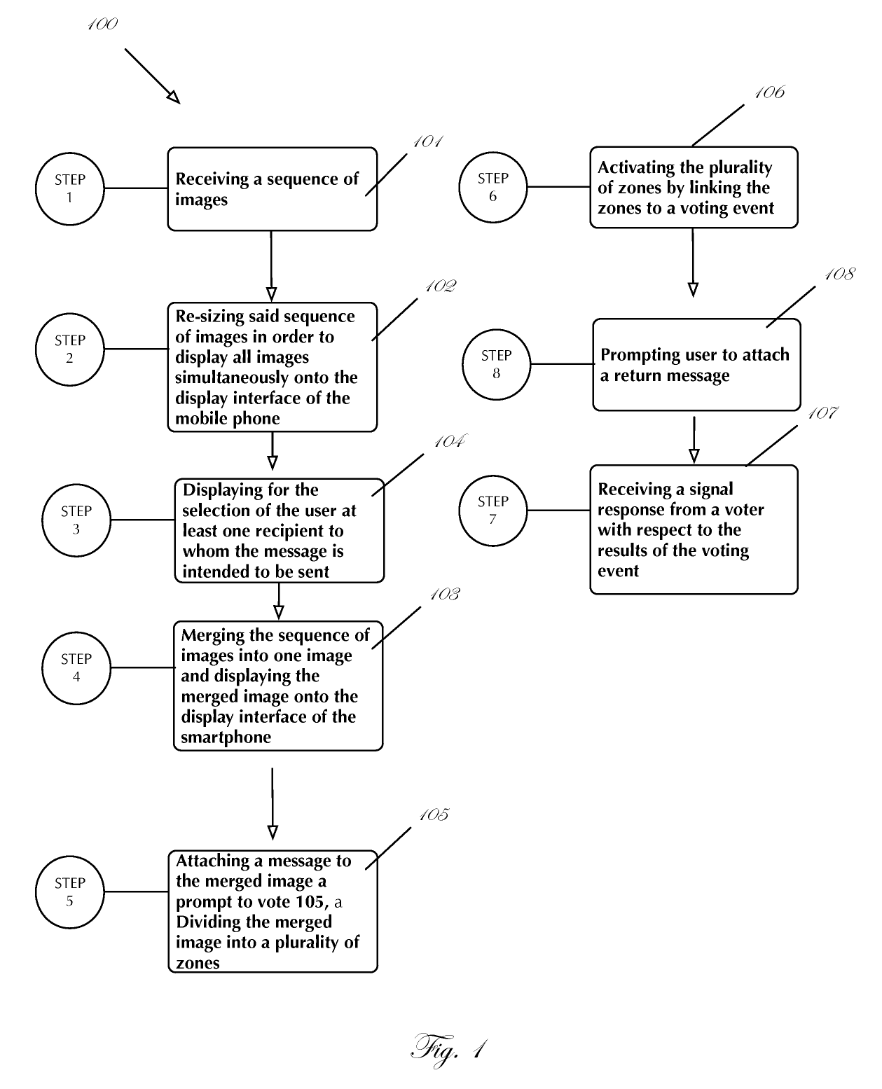

FIG. 1 illustrates that the Mobile Application for Executing Voting Events using images between smart phones 100 includes Receiving a sequence of images 101, Re-sizing said sequence of images in order to display all images simultaneously onto the display interface of the mobile phone 102, Merging the sequence of images into one image and displaying the merged image onto the display interface of the smartphone, 103, Displaying for the selection of the user at least one recipient to whom the message is intended to be sent 104, Attaching a message to the merged image a prompt to vote 105, Dividing the merged image into a plurality of zones 106, Activating the plurality of zones by linking the zones to a voting event 107, Receiving a signal response from a voter with respect to the results of the voting event 108, and Prompting user to attach a return message, 109. In one alternative embodiment steps 3 and 4 may be reversed in sequence.

In one embodiment, the method is executed on a computer system. This computer system executes a computer program to accomplish the aforementioned steps.

Receiving a sequence of images 101 is used for the purpose of collecting the shots or images a user will take from their smartphone so that they may be able to disseminate those images for a vote. It may also be accomplished by simply downloading those images from a website or other source. For the purposes of the present embodiment, it is not necessary that the images actually be captured by the smartphone, or client. The mere importation of those images will suffice.

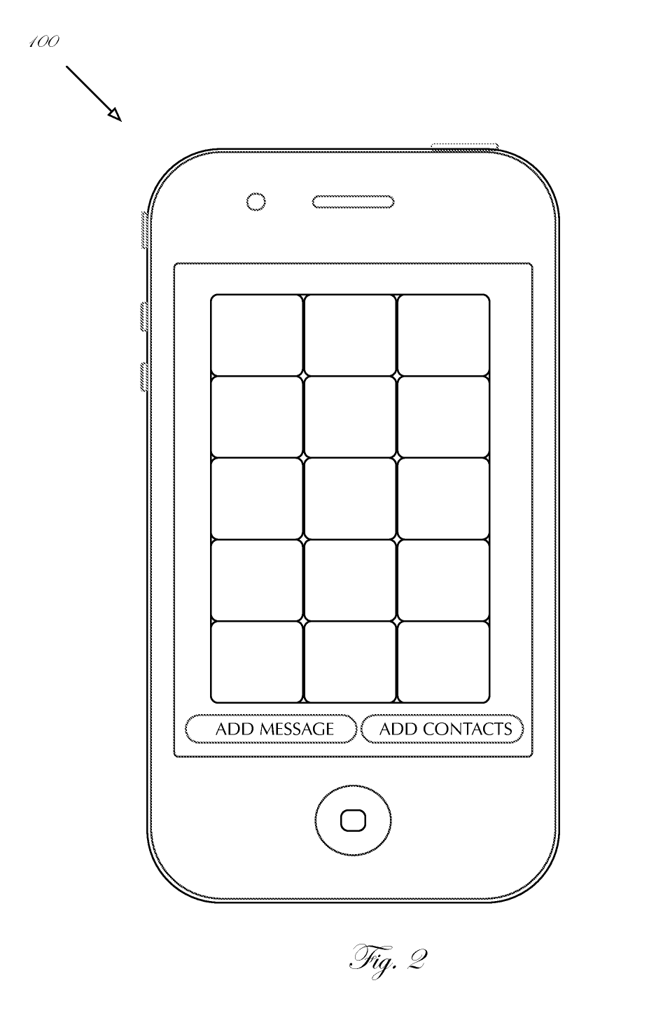

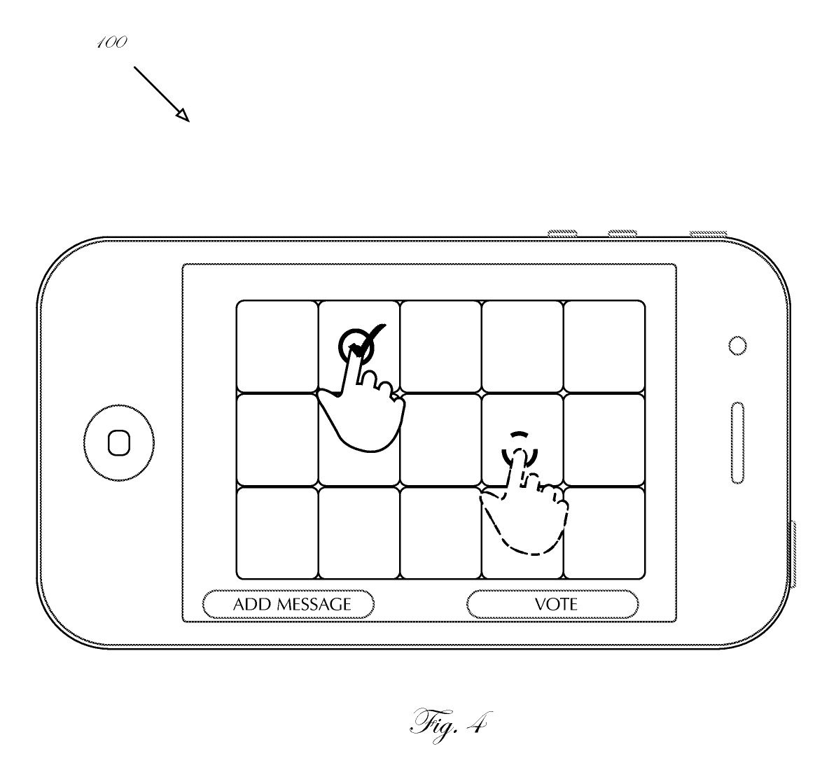

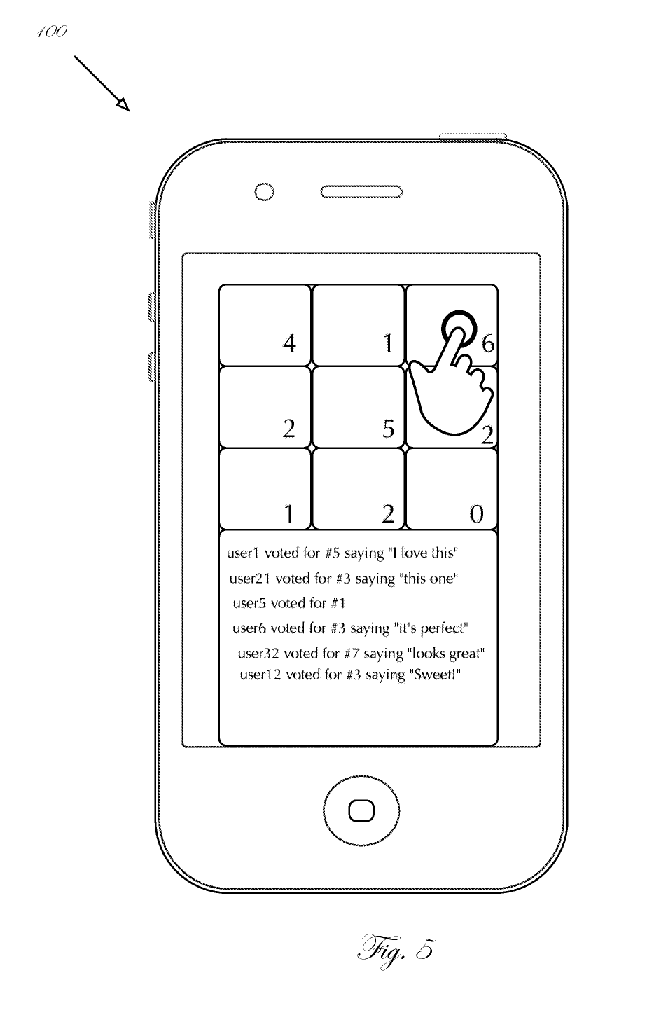

FIG. 2 illustrates the next step of Re-sizing said sequence of images in order to display all images simultaneously onto the display interface of the mobile phone 102 is used for the purpose of getting all the images onto the display interface of their smartphone. Since most smartphones will display images such that they will completely fill the screen, those images will have to be re-sized. It is important to merge those images all in one screen to enable a recipient the ability to quickly and easily compare those images without having to flip back and forth amongst the sequence of images. This juxtaposition may take place in either landscape mode or in portrait mode as illustrated in FIGS. 4-5. The algorithms inherent in the mobile application will be able to discern where it may be appropriate, given the subject matter, the various sizes of the individual pictures, etc. which mode will be most appropriate. Or, in the alternative, the mobile application may have a user preference menu which will enable client or user to select a preferred mode be it landscape or portrait mode.

Displaying for the selection of the user at least one recipient to whom the message is intended to be sent 104 is used for the purpose of taking the vote. FIG. 5 illustrates the step of Attaching a message to the merged image a prompt to vote 105 is used for the purpose of enabling the voters/recipients the ability to add additional feedback regarding the images.

Dividing the merged image into a plurality of zones 106 is used for the purpose of enabling a person, voter, or recipient to vote on one of the images of the merged image. When a person taps with their finger onto that zone, a subsequent signal response will be attributed to a vote attribute which will then be used to tally up and tabulate the results of the voting event.

Activating the plurality of zones by linking the zones to a voting event is similar to making it a hypertext link in the sense that when the user/recipient/voter taps or otherwise activates that zone, the subsequent signal will be attributed to a particular vote.

Receiving a signal response from a voter with respect to the results of the voting event 108 is used for the purpose of recording the votes. It should be noted that in some embodiments, the vote will be simply asking a user/recipient/voter which image, or which object in the image they believe is the best or the worst. In other embodiments, the voter will be able to vote, rate, grade, judge, appraise, or valuate each image individually through various well-known methods. Some may be on a point system (ie “1-100 scale”, “A,B, C, D, F” “5 Stars”, etc.).

Prompting user to attach a return message 109 is used for the purpose of enabling a user, recipient, voter the ability to add more information about their opinions of the image. In one embodiment, Prompting user to attach a return message 109 is done through text message. In other embodiments it may be through email, SMS, or even a voice recording to be sent out as an attachment.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A System for providing a voting event incorporating images with a mobile device, the system comprising:
an interface for receiving a sequence of images;
an interface for re-sizing said sequence of images in order to display all images simultaneously onto the display interface of the mobile phone;
an interface for merging the sequence of images into one image and displaying the merged image onto the display interface of the smartphone;
an interface for displaying for the selection of the user at least one recipient to whom the message is intended to be sent;
an interface for attaching a message to the merged image a prompt to vote;
an interface for dividing the merged image into a plurality of zones;
an interface for activating the plurality of zones by linking the zones to a voting event;
an interface for receiving a signal response from a voter with respect to the results of the voting event.

2. A method for delivering images for the purposes of voting between mobile devices, the method comprising:
receiving a sequence of images;
merging the sequence of images into one image and displaying the merged image onto the display interface of the smartphone;
displaying for the selection of the user at least one recipient to whom the message is intended to be sent;
attaching a message to the merged image a prompt to vote;
dividing the merged image into a plurality of zones;
activating the plurality of zones by linking the zones to a voting event;
receiving a signal response from a voter with respect to the results of the voting event.

3. A computer-readable storage medium storing computer-executable instructions for causing a computer to perform a method, the method comprising:
receiving a sequence of images;
merging the sequence of images into one image and displaying the merged image onto the display interface of the smartphone;
displaying for the selection of the user at least one recipient to whom the message is intended to be sent;
attaching a message to the merged image a prompt to vote;
dividing the merged image into a plurality of zones;
activating the plurality of zones by linking the zones to a voting event;
receiving a signal response from a voter with respect to the results of the voting event.
